(19) United States
(12) Patent Application Publication
(10) Pub. No.: US 2014/0117753 A1
(43) Pub. Date: May 1, 2014

(54) SYSTEM OF DISTRIBUTING ELECTRIC CURRENT TO ELECTRICAL OUTLETS OF A PASSENGER VEHICLE

(71) Applicant: ECE, Paris (FR)

(72) Inventors: Jean-Clair PRADIER, Houilles (FR); Pascal GORDIET, Saint Georges Sur La Pree (FR)

(73) Assignee: ECE, Paris (FR)

(21) Appl. No.: 14/060,081

(22) Filed: Oct. 22, 2013

Related U.S. Application Data
(60) Provisional application No. 61/723,572, filed on Nov. 7, 2012.

(30) Foreign Application Priority Data
Oct. 25, 2012 (FR) 1260175

(51) Int. Cl. B60R 16/02; H02M 5/04

(52) U.S. Cl. CPC B60R 16/02; H02M 5/04
USPC 307/9.1

(57) ABSTRACT

The invention relates to a system of distributing electric current to electrical outlets of a passenger vehicle, said distribution system comprising:
a power source capable of delivering an electric current;
distribution units equipped with electrical outlets;
a power converter having an input connected to the power source in order to convert the electric current delivered by the power source, the power converter being a common power converter having one or more outputs connected to all the distribution units of the distribution system for transmitting the converted electric current to the electrical outlets of all the distribution units of the distribution system. At least one electrical outlet is a USB port. Each distribution unit additionally comprises a secondary power converter having an input connected to an output of the common power converter and at least one output connected to said USB port.

### CROSS-REFERENCE TO RELATED APPLICATIONS

This application claims the benefit of priority of French Patent Application No. 1260175 filed Oct. 25, 2012, and U.S. Provisional Application No. 61/723,572, filed Nov. 7, 2012, all of which are incorporated by reference in their entirety herein.

### BACKGROUND

The invention relates to a system of distributing electric current to the electrical outlets of a cabin of a passenger vehicle, such as an airplane or a train.

A distribution system, known in particular from U.S. Pat. No. 6,046,513, comprises a central power source and a central control unit connected to the power source. This distribution system also comprises a plurality of groups of local distribution units connected to the central control unit. Each group, generally called a column, comprises a plurality of distribution units connected to each other. Each distribution unit is equipped with electrical outlets. The central power source is capable of transferring to the distribution units a three-phase alternating current at 115 volts. Each distribution unit contains a converter capable of converting the received alternating current of 115 volts, 400 Hz into an alternating current of 110 Volts, 60 Hz which is supplied to the electric outlets.

Such a distribution system comprises a great number of power converters, each power converter being able to supply electrical power only to three or fourth seats.

Such a distribution system has a significant mass and an important volume. This distribution system is poorly suited for smaller carriers. Further, this distribution system does not offer the commodity of providing electrical power by way of USB ports. This commodity is more and more requested with the increase of the number and services offered by the portable cellular phones and the increasing use of laptops, tablets, or music players.

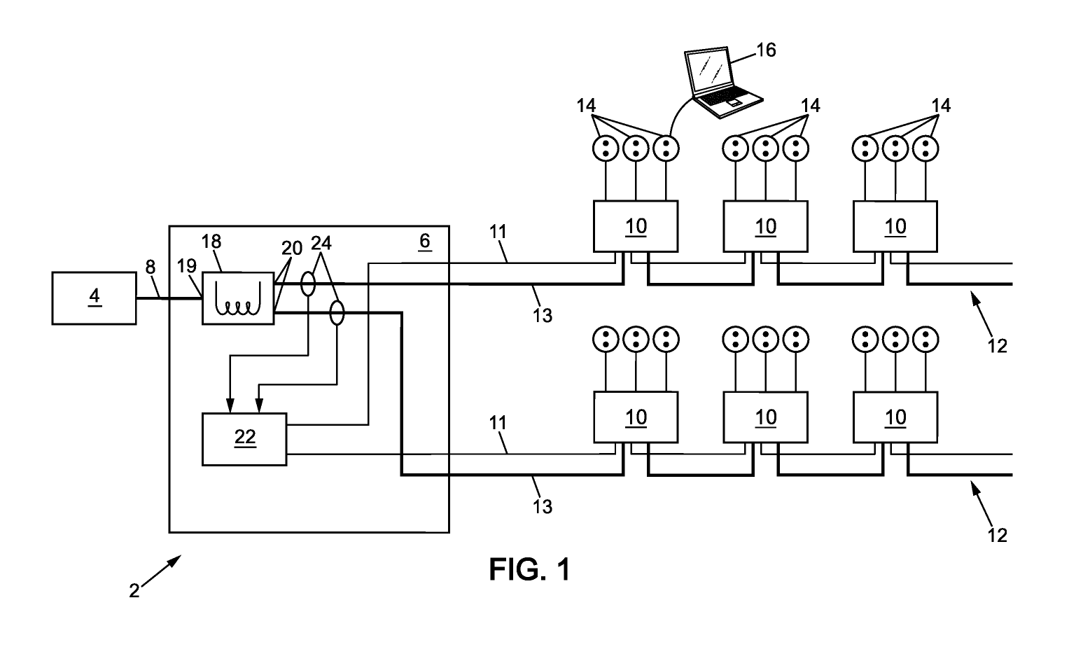

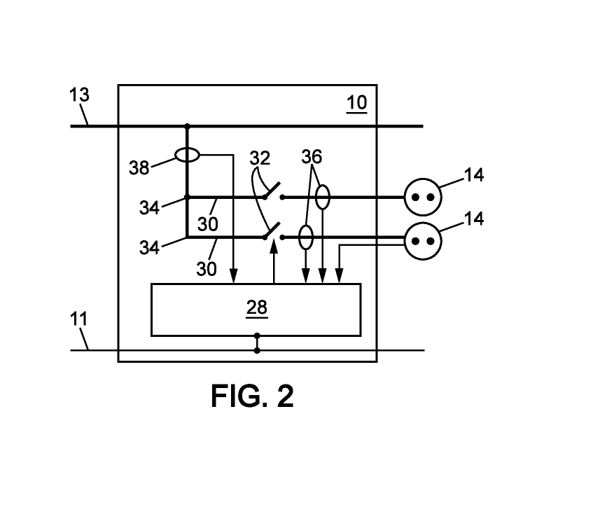

For example by document EP 1 650 846, a distribution system comprising a converter common to the distribution units of the system is also known. Such a system is described in relation to FIGS. 1 and 2 of the present patent application.

This system is not adapted to the supply of power to USB ports because USB ports are fed with high current (around 2 Amperes) at low voltage (around 5 Volts). To prevent power conveyance loss, this current must be transported on cables having important diameter. However, these cables, made of copper, are expensive. Further, when the diameter of the cable is increased, the airplane mass and the quantity of kerosene needed to move the airplane are also increased.

The purpose of the present invention is to provide a distribution system of reduced mass and volume and which offers the commodity of providing USB ports. To this end, the invention relates to a system of distributing electric current to electrical outlets of a passenger vehicle, said distribution system comprising:

a power source capable of delivering an electric current;

distribution units equipped with electrical outlets;

a power converter having an input connected to the power source in order to convert the electric current delivered by the power source;

the power converter being a common power converter having one or more outputs connected to all the distribution units of the distribution system in order to transmit the converted electric current to the electrical outlets of all the distribution units of the distribution system, wherein at least one electrical outlet is a USB port, and wherein each distribution unit additionally comprises a secondary power converter having an input connected to an output of the common power converter and at least one output connected to said USB port.

Advantageously, the use of both a power converter common to the distribution units and a secondary power converter put in each distribution unit allows to reduce the mass and the volume of the system because each secondary power converter can supply electrical power to ten to fifteen seats and cables having optimized diameter can be implemented in the airplane.

In certain embodiments of the invention, the distribution system comprises one or more of the following characteristics:

all the electrical outlets in all the distribution units are USB ports.

the system comprises a control module able to transmit to the distribution units a signal authorizing or not authorizing the delivery of current to each electrical outlet, and wherein the distribution units each comprise a cutoff device able to authorize or cut off the delivery of electric current to at least one electrical outlet.

the distribution system comprises at least one residual current device connected to an output from the common power converter.

the common power converter is able to convert a three-phase alternating current of 115 volts at a frequency of 400 Hertz into a single phase alternating current of 110 volts at a frequency of 60 Hertz.

the secondary power converter is able to convert the single phase alternating current of 110 volts at a frequency of 60 Hertz into a direct current.

the common power converter is able to convert a three phase alternating current of 115 volts at a frequency of 400 Hertz into a single phase direct current of 42 volts.

the secondary power converter is able to convert the single phase direct current of 42 volts into a direct current.

The invention will be better understood upon reading the following description given purely by way of example and with reference to the attached drawings, in which:

FIG. 1 is a schematic view of a distribution system according to the state of the art;

FIG. 2 is a simplified diagram showing a distribution unit of the distribution system shown in FIG. 1;

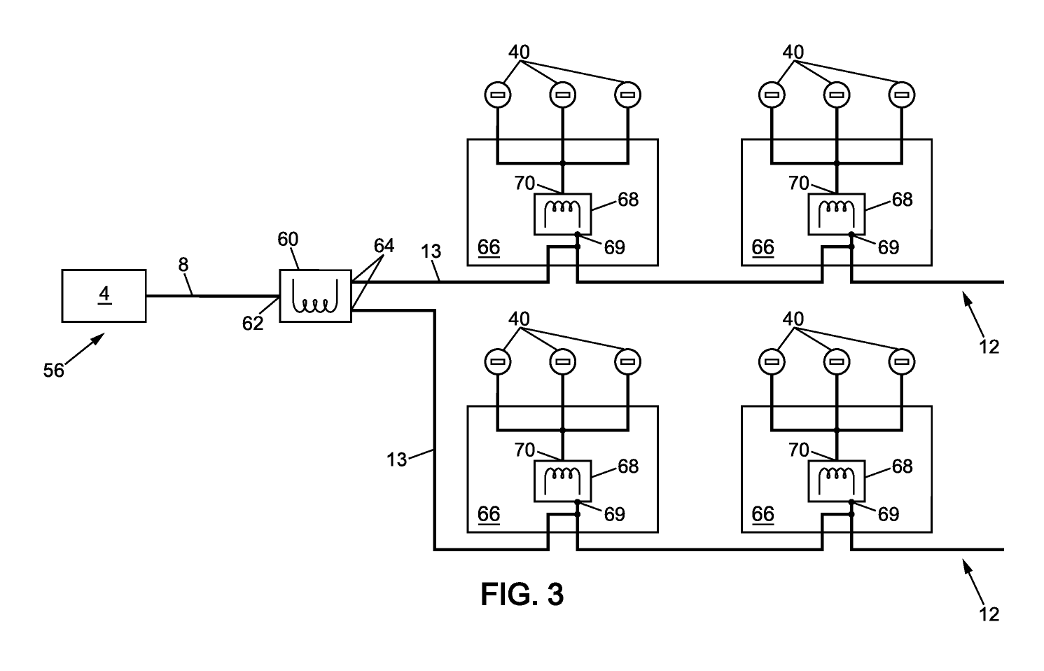

FIG. 3 is a schematic view of a distribution system according to a first embodiment of the invention;

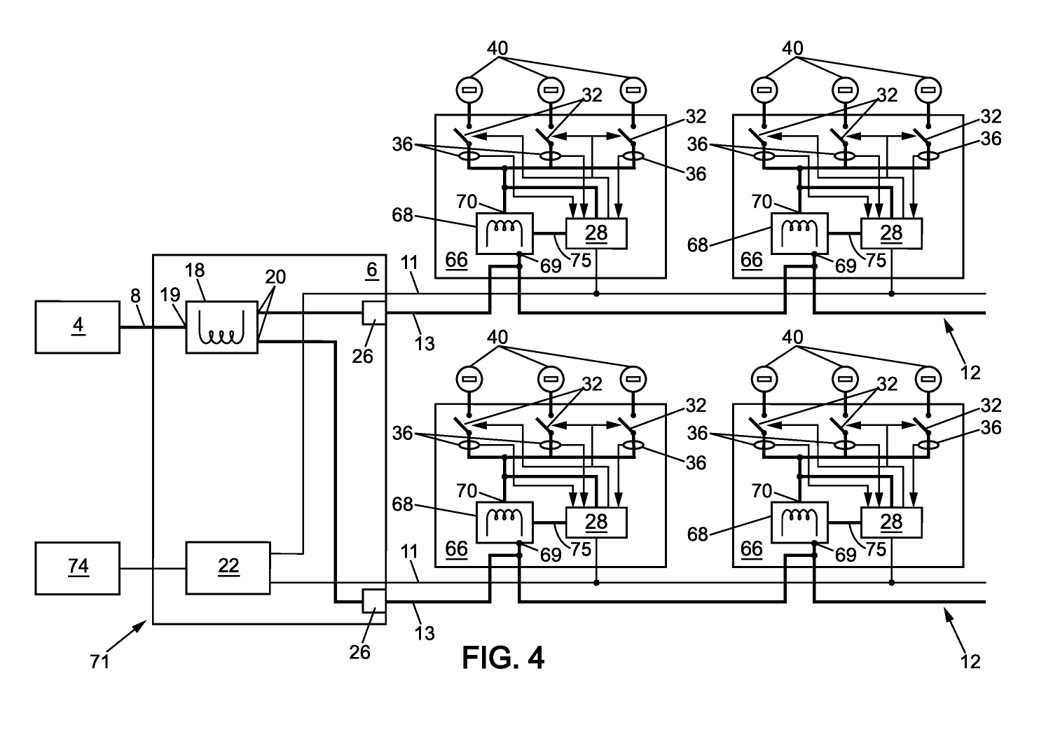

FIG. 4 is a schematic view of a distribution system according to a second embodiment of the invention; and

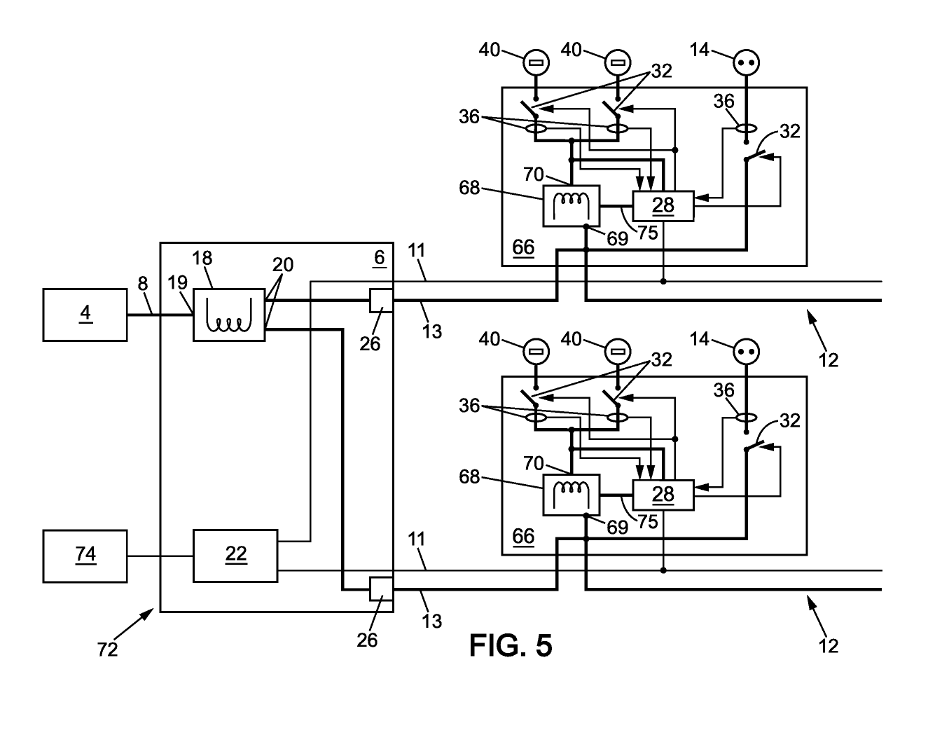

FIG. 5 is a schematic view of a distribution system according to a third embodiment of the invention.

Referring to FIG. 1, the system 2 for distributing electric current comprises a power source 4 commonly called an EPDS (Electrical Power Distribution System), and a central control unit 6 commonly called an MCU (Master Control Unit) connected to the central power source 4 by a first power line 8.

The distribution system 2 additionally comprises local distribution units 10, generally called SPB (Seat Power Boxes), installed next to the passenger seats and distributed throughout the aircraft cabin.

The distribution units 10 are divided into groups of distribution units commonly called columns 12. The columns 12 are connected in parallel to each other. Each column 12 is connected to the central control unit 6 by a second power line 13 and by a bidirectional communication line 11. In each column 12, the distribution units 10 are serially connected to each other and to the central control unit 6 by the second power line 13 and by the communication line 11.

To simplify FIG. 1, only two columns 12 have been represented. In practice, the distribution system may comprise one column 12 or more than two columns 12.

The distribution units 10 are equipped with electrical outlets 14 intended to receive personal electronic devices 16 such as a laptop, tablet, or music player. Each electrical outlet 14 comprises a detector capable of detecting the introduction of a plug 10 into the outlet and of generating a signal interpreted by the microprocessor of the distribution unit 10 as a request for distribution of electric current.

The power source 4 is capable of supplying the central control unit 6 with a three-phase alternating current of 115 volts at a frequency of 400 Hz by means of the first power line 8.

Preferably, the communication line 11 consists of the single wire already equipping current aircraft and generally called a keyline, for example by implementing a single wire low speed CAN communication bus such as the bus called SWCAN (Single Wire CAN). As a variant, the communication line 11 consists of a CAN or RS485 type of communication line.

The central control unit 6 comprises a common power converter 18 capable of converting the electric current delivered by the central power source 4 into a voltage and frequency usable by personal electronic devices 16. The common power converter 18 has an input 19 connected to the central power source 4 by the first power line 8, and outputs 20 each connected to all distribution units 10 of each column 12, by the second power lines 13. Thus the electric current converted by the common power converter 18 is transmitted to the electrical outlets 14 of all the distribution units 10 of the distribution system 2.

The common power converter 18 can convert the three-phase alternating current of 115 volts into a voltage and current wholly suitable for the use made of it in the cabin. Preferably, the common power converter 18 converts the current originating from the central power source 4 into a single-phase alternating current of 110 volts at a frequency of 60 Hz.

The central control unit 6 additionally comprises a control module 22 and current sensors 24 mounted on each second power line 13 for measuring the electric current transmitted to the distribution units 10 in each column 12. The control module 22 comprises a central processing unit CPU. It consists, for example, of a microprocessor.

The control module 22 is capable of comparing the measured electric currents to predefined threshold values and transmitting to the distribution units 10 commands authorizing or not authorizing the delivery of current to an electrical outlet 14 which has requested current, based on the result of this comparison.

The control module 22 is capable of transmitting a signal to power on or off the electrical outlets 14 in the distribution units 10 during takeoff and landing. It is also capable of sending information to a cabin management system (not represented) regarding failures in itself and in the electrical outlets.

With reference to FIG. 2, each distribution unit 10 comprises a calculation unit 28 connected to the communication line 11, electrical outlets 14 connected to the corresponding second power line 13 on shunt branches 30 mounted in parallel to each other, and switches 32 connected to each shunt branch 30 between a shunt node 34 and the electrical outlet 14.

In FIG. 2, only two electrical outlets 14 have been represented to simplify the representation. In practice, the distribution unit 10 generally comprises four electrical outlets 14.

The calculation unit 28 comprises a central processing unit CPU. It is capable of transmitting the distribution requests originating from electrical outlets 14 to the control module 22 of the central control unit 6, receiving the order to authorize or not authorize the delivery of electric current, and then controlling accordingly the opening or closing of the switch 32 connected to the electrical outlet which made the distribution request. The calculation unit 28 and the switch 32 form a device for cutting off the delivery of electric current to an electrical outlet.

The calculation unit 28 additionally comprises current sensors 36, each connected to a shunt branch 30, and a current sensor 38 connected between the second power line 13 and the shunt nodes 34. The current sensors 36 and 38 are capable of measuring and communicating to the calculation unit 28, respectively, the intensity of the electric current distributed to each electrical outlet 14 and the intensity of the electric current distributed to all the distribution units 10. The calculation unit 28 sends these values to the central control unit 6, via the communication line 11.

The calculation unit 28 is able to determine failures and outages in the electrical outlets 14 and to send this failure information to the control module 22, by the communication line 11.

As a variant, the distribution units 10 do not contain current sensors 36 and 38. In this case, the central control unit 6 only uses the intensity of the electric current distributed in each column 12 to choose whether or not to authorize distribution of electric current to an electrical outlet 14 which requests it.

The common power converter 18 is the only power converter of the distribution system capable of delivering electric current to all the electrical outlets 14 of the distribution system 2. The distribution units 10 do not contain any additional power converter. The electric current converted by the common power converter 18, for example into a single phase alternating current of 110 volts at a frequency of 60 Hz, is supplied directly to the electrical outlets 14.

During operation, the electric current generated by the central power source 4 is converted by the common power converter 18 and is distributed to all the distribution units 10. When a passenger introduces a plug into an electrical outlet 14, the distribution unit 10 equipped with this electrical outlet 14 sends a distribution request on the communication line 11 to the control module 22. The control module 22 determines the instantaneous electric current distributed by the corresponding power line, compares it to the threshold values, and sends an authorization or non-authorization command to the corresponding distribution unit 10 based on the result of the comparison. When the calculation unit 28 receives a distribution authorization command, it orders the corresponding switch 32 to close. The electric current converted by the common power converter 18 is supplied to the electrical outlet which requested it.

In this manner, the common power converter 18 converting electric current into a voltage and frequency usable by personal electronic devices 16 supplies electric current to all the distribution units 10. The distribution units 10 no longer contain a 110V power converter and are only in charge of distribution of electric current to the electrical outlets 14.

The distribution system according to the first embodiment of the invention represented in FIG. 3 is a low cost system providing a response to the new demands of passengers or airlines. More and more passengers simply want access to a USB port in order to plug in their tablets or cell phones. Similarly, more and more airlines are providing tablets to passengers who want them.

With reference to FIG. 3, the distribution system 56 according to the first embodiment of the invention comprises a common power converter 60. It is able to convert the three-phase alternating current of 115 Volts at a frequency of 400 Hertz, originating from the central power source 4, into a direct current of low voltage, for example 42 Volts. It has an input 62 connected to the central power source 4 and outputs 64 connected to all the distribution units 66 of the distribution system.

In this embodiment of the invention, all the electrical outlets 14 of all distribution units 66 are USB ports 40, and each of the distribution units 66 comprises a secondary power converter 68 with its input 69 connected to the common power converter 60 via the power line 8 and its output 70 connected to the USB ports 40 assembled in parallel to each other. The secondary power converter 68 is able to convert the direct current of 42 volts originating from the common power converter 60 into a low voltage direct current suitable for powering the USB ports 40.

The central power source 4 is designed to have sufficient power to supply all the passengers without limitation. Thus the distribution system does not comprise any central control unit for managing the distribution of electric current to the electrical outlets nor any calculation unit installed in the distribution units.

Advantageously, the low voltage direct current minimizes the need for personnel protection and simplifies certification.

The elements of the distribution system 71 according to the second embodiment of the invention that are identical to the elements of the distribution systems described here above are designated by the same references and are not described again here.

The distribution system 71 according to the second embodiment of the invention represented in FIG. 4 comprises a central power source 4, a central control unit 6 connected to the central power source 4 by a first power line 8, and local distribution units 66 connected, in each column 12, serially to each other and to the central control unit 6 by a second power line 13 and by a bidirectional communication line 11. The columns 12 are connected in parallel to each other. The local distribution units 66 are equipped with USB ports 40.

The power source 4 is able to deliver an alternating current of 115 Volts.

The central control unit 6 comprises a common power converter 18 able to convert the electric current delivered by the central power source 4 into an alternating current of 110 volts 60 Hertz or a direct current of 42 volts, and a control module 22 connected to the calculation units 28 of the distribution units 66 by the communication line 11 and to the cabin management system 74 (CMS) in order to indicate its own failures and failures in the distribution units 10.

The control module 22 is able to transmit a signal to the distribution units 66 to supply or cut off power to the USB ports 40, during takeoff and landing phases. The control module 22 is able to transmit a signal controlling the delivery or non-delivery of current to a particular USB port at the command of a member of the aircraft crew. It is also able to send information to the cabin management system 74 concerning its own failures and failures in the USB ports 40.

The control module 22 is able to record the value of the current delivered to each USB port 40 and to add it in order to allow displaying the electricity consumed by each USB port 40 and therefore the electricity consumed by each passenger, at the end of the flight.

The central control unit 6 additionally comprises a circuit breaker 26 mounted on each second power line 13 to protect the central control unit 6 against overload and ground fault.

The distribution units 66 are similar to the distribution units 66 of the distribution system according to the first embodiment except for the fact that they additionally contain a current sensor 36 and a switch 32 mounted upstream from each USB port 40, as well as a calculation unit 28 connected, by a communication line, to the current sensors 36 and to the switches 32.

The current sensors 36 are able to measure the current delivered to each USB port 40 and to send this value to the calculation unit 28.

The calculation unit 28 is able to order the delivery or the termination of delivery of electric current to a particular USB port 40, by a command to open or close an individual switch 32 upon receipt of the delivery or non-delivery signal sent by the control module 22.

The calculation unit 28 is connected to the secondary power converter 68 by a power and communication line 75, and to the communication line 11. It is able to order the termination of delivery of electric current to all USB ports 40 by means of the secondary power converter 68 or by controlling all switches 32 upon receipt of a power-off signal sent by the control module 22.

The calculation unit 28 is connected to the output 70 from the secondary power converter 68 in order to copy the voltage output from the secondary power converter 68 and determine failures in the USB ports based on this voltage. Lastly, the calculation unit 28 is adapted to transmit this failure information as well as the values of the current intensities consumed by each USB port 40 to the control module 22, by the communication line 11.

In this embodiment, the secondary power converter 68 is able to convert the voltage issuing from the primary power converter 60 from 110 volts 60 Hertz alternating current, or 42 volts direct current, into a direct current of between 3 volts and 15 volts and preferably equal to 5 Volts.

Advantageously, the aircraft crew can control each switch 32 individually by means of the control module 22, meaning by means of a central processing unit CPU. An individual control device for each switch 32, as well as the implementation of a current sensor 36 able to measure the consumption of each USB port 40, allows the crew to invoice each passenger individually for their electricity usage. This invoicing is easily done by accessing the control unit 22 only.

As a variant, the distribution units 66 of the distribution system 71 according to the fourth embodiment do not contain switches 32, as in the embodiment described in relation to FIG. 5.

In a large carrier, for example an A320 or A330, several distribution systems must be installed in order to distribute electric current to all seats in the cabin. If, for example, the common power converter 18, 60 is designed to supply 1500 Watts, it can provide 110 volts to 15 seats or 5 volts to a hundred seats.

The distribution system 72 according a third embodiment represented on FIG. 5 is identical to the distribution system 71 according to the second embodiment at the exception of the fact that the distribution unit 66 comprises further an electrical outlet 14 connected straight to the second power line 13. A switch 32 controlled by the calculation unit 28 is connected between the electrical outlet 14 and the connection point to the second power line 13. The electrical outlet 14 supplies electrical power only converted by the common power converter 18. This electrical power does not passed through the secondary power converter 68.

A current sensor 36 is connected on the current line feeding the electrical power 14, between the switch 32 and the connection to the second power line 13. This current sensor 36 is capable of measuring and communicating to the calculation unit 28, the intensity of the electric current distributed to the electrical outlet 14.

When the common power converter converts a three-phase alternating current into a single phase alternating current of 110 volts at a frequency of 60 Hertz, the calculation unit 28 is able to implement a protective function, such as a differential ground fault interrupter GFI intended to protect passengers from electric shocks.

In all the embodiments described, the secondary power converter is localized near the seats.

1. System of distributing electric current to electrical outlets of a passenger vehicle, said distribution system comprising:
a power source capable of delivering an electric current;
distribution units equipped with electrical outlets;
a power converter having an input connected to the power source in order to convert the electric current delivered by the power source, the power converter being a common power converter having one or more outputs connected to all the distribution units of the distribution system in order to transmit the converted electric current to the electrical outlets of all the distribution units of the distribution system,
wherein at least one electrical outlet is a USB port, and wherein each distribution unit additionally comprises a secondary power converter having an input connected to an output of the common power converter and at least one output connected to said USB port.

2. Distribution system according to claim 1, wherein all the electrical outlets in all the distribution units are USB ports.

3. Distribution system according to claim 1, wherein the system comprises a control module able to transmit to the distribution units a signal authorizing or not authorizing the delivery of current to each electrical outlet, and wherein the distribution units each comprise a cutoff device able to authorize or cut off the delivery of electric current to at least one electrical outlet.

4. Distribution system according to claim 1, comprising at least one residual current device connected to an output from the common power converter.

5. Distribution system according to any one of claim 1, wherein the common power converter is able to convert a three-phase alternating current of 115 volts at a frequency of 400 Hertz into a single phase alternating current of 110 volts at a frequency of 60 Hertz.

6. Distribution system according to claim 5, wherein the secondary power converter being able to convert the single phase alternating current of 110 volts at a frequency of 60 Hertz into a direct current.

7. Distribution system according to claim 1, wherein the common power converter is able to convert a three phase alternating current of 115 volts at a frequency of 400 Hertz into a single phase direct current of 42 volts.

8. Distribution system according to claim 7, wherein the secondary power converter being able to convert the single phase direct current of 42 volts into a direct current.
